(19) United States
(12) Patent Application Publication
(10) Pub. No.: US 2014/0330523 A1
(43) Pub. Date: Nov. 6, 2014

(54) METHOD OF ENHANCING FLAT SPOTS IN THREE-DIMENSIONAL SEISMIC INTERPRETATION

(71) Applicants: Jerzy R. TRYBEK, Sugar Land, TX (US); John J. Bornhurst, Austin, TX (US); Mark Busby, Bangkok (TH); Kevin L. Deal, Houston, TX (US)

(72) Inventors: Jerzy R. TRYBEK, Sugar Land, TX (US); John J. Bornhurst, Austin, TX (US); Mark Busby, Bangkok (TH); Kevin L. Deal, Houston, TX (US)

(73) Assignee: Chevron U.S.A. Inc., San Ramon, CA (US)

(21) Appl. No.: 13/875,879

(22) Filed: May 2, 2013

(51) Int. Cl. G01V 1/28; G01V 1/34

(52) U.S. Cl. CPC G01V 1/28; G01V 1/345
USPC 702/16

(57) ABSTRACT

Embodiments of a method for enhancing flat spots in 3D seismic interpretation are disclosed herein. Embodiments of the method generally involve an operation of horizontally stacking (summing) traces within a user defined elongate area. The user may define the size and shape of the elongate area. In addition, the elongate area may be automatically aligned to a user defined axis such as without limitation, the structure strike. By aligning an elongate area operator with a selected or user selected axis, and with appropriate choice of axis length, it is possible to constrain the stacking operation within geologic strata, allowing the user to image even narrow flat events that wrap around a subterranean structure. Further details and advantages of various embodiments of the method are described in more detail herein.

### CROSS-REFERENCE TO RELATED APPLICATIONS

Not applicable.

### STATEMENT REGARDING FEDERALLY SPONSORED RESEARCH OR DEVELOPMENT

Not applicable

### BACKGROUND

1. Field of the Invention

This invention relates generally to the field of geophysical exploration for hydrocarbons. More specifically, the invention relates to a method of flat spot enhancement in three-dimensional seismic processing and interpretation.

2. Background of the Invention

A seismic survey is a method of imaging the subsurface of the earth by delivering acoustic energy down into the subsurface and recording the signals reflected from the different rock layers below. The source of the acoustic energy typically comes from a seismic source such as without limitation, explosions or seismic vibrators on land, and air guns in marine environments. During a seismic survey, the seismic source may be moved across the surface of the earth above the geologic structure of interest. Each time a source is detonated or activated, it generates a seismic signal that travels downward through the earth, is reflected, and, upon its return, is recorded at different locations on the surface by receivers. The recordings or traces are then combined to create a profile of the subsurface that can extend for many miles. In a two-dimensional (2D) seismic survey, the receivers are generally laid out along a single straight line, whereas in a three-dimensional (3D) survey the receivers are distributed across the surface in a grid pattern. A 2D seismic line provides a cross sectional picture (vertical slice) of the earth layers as arranged directly beneath the recording locations. A 3D survey produces a data “cube” or volume that theoretically represents a 3D picture of the subsurface that lies beneath the survey area.

In the oil and gas industry, the primary goal of seismic exploration is locating subterranean features of interest within a very large seismic volume. Rock stratigraphic information may be derived through the analysis of spatial variations in a seismic reflector's character because these variations may be empirically correlated with changes in reservoir lithology or fluid content. Since the exact geological basis behind these variations may not be well understood, a common method is to calculate a variety of attributes from the recorded seismic data and then plot or map them, looking for an attribute that has some predictive value. Given the extremely large amount of data collected in a 3-D volume, methods of enhancing the appearance of subsurface features related to the migration, accumulation, and presence of hydrocarbons are extremely valuable in seismic exploration.

One particular attribute known as “flat spots” is especially useful to seismic interpreters. Seismic flat spots are generally caused by the interface between two different types of fluids in a reservoir. This phenomenon is frequently used as a direct hydrocarbon indicator in conjunction with seismic amplitudes and AVO techniques in exploring for hydrocarbons. Knowledge of the location and extents of suspected hydrocarbon fluid contacts can hold great weight in business decisions related to drilling and production of known reservoirs, and plays an important role in reconnaissance screening in the exploration work process. Fluid contacts in reservoirs are often difficult or impossible to see on conventional seismic sections displayed in seismic interpretation systems due to noise, dipping events, low amplitude supports, and other subsurface effects. The ability to quickly and reliably identify candidates for further examination allows interpreters to apply experience and knowledge to classify them as the result of HC fluid contacts or other seismic artifacts. The state of the art is the ability to produce flat spot candidates through other methods.

While most hydrocarbon contacts are physically flat, much like the surface of a calm body of water, they may not appear flat in the seismic data, depending on whether the vertical unit of the seismic data is time or depth, or, in the case of offshore data, whether the water bottom is relatively constant depth or rapidly changing. The common property that the contacts share is that they form regions of connected samples with a similar property, in a roughly horizontal configuration. A common way of addressing this problem is by exploiting this property in some way. The approach is to find events that are approximately flat, then to figure out what they are. It should be understood that current methods are limited in their capability; all strive to detect a flat event, spots, or areas, but none have the ability to decisively classify a flat event as a hydrocarbon contact.

Consequently, there is a need for methods and systems to enhance flat spots in the field of 3D seismic processing and interpretation.

### BRIEF SUMMARY

Embodiments of a method for enhancing flat spots in 3D seismic interpretation are disclosed herein. Embodiments of the method generally involve an operation of horizontally stacking (summing) traces within a user defined elongate area. The user may define the size and shape of the elongate area. Furthermore, the elongate area may be automatically aligned to a user defined axis such as without limitation, the structure strike. By aligning or orienting an elongate area operator with a selected or user selected axis, and with appropriate choice of axis length, it is possible to constrain the stacking operation within geologic strata, allowing the user to image even narrow flat events that wrap around a subterranean structure. The resulting output from the disclosed methods may also be weighted with covariate attributes that reflect other properties embedded within the seismic data. Further details and advantages of various embodiments of the method are described in more detail below.

In an embodiment, a method of enhancing a flat spot for seismic interpretation comprises: a) selecting a three-dimensional (3D) seismic input volume representing a subterranean region. The 3D seismic input volume comprises a plurality of seismic traces. The method also comprises: (b) defining an elongate area along a horizontal plane. The elongate area is centered on an individual seismic trace within the seismic input volume, and the elongate area encloses a subset of the plurality of seismic traces. Furthermore, the method comprises: (c) automatically aligning the elongate area in relation to a user defined axis. In addition, the method comprises (d) performing a stack of the subset of traces defined by the elongate area and outputting a result to a 3D seismic output volume. The method also comprises: (e) repeating (c) and (d) for each sample point down the individual seismic trace and outputting each result to the 3D seismic output volume; and (f) positioning the elongate area on another individual seismic trace and repeating (c) through (e). At least one of (a) through (f) is performed on a computer.

In another embodiment, a computer system for enhancing flat spots comprises an interface for receiving a 3D seismic input volume, the 3D seismic input volume comprising a plurality of seismic traces. The computer system further comprises a memory resource. In addition, the computer system comprises input and output functions for presenting and receiving communication signals to and from a human user. The computer system also comprises one or more central processing units for executing program instructions and program memory coupled to the central processing unit for storing a computer program including program instructions that when executed by the one or more central processing units, cause the computer system to perform a plurality of operations for enhancing flat spots within the seismic input volume. The plurality of operations comprise: (a) defining an elongate area along a horizontal plane, wherein the elongate area is centered on an individual seismic trace within the seismic input volume. The elongate area encloses a subset of the plurality of seismic traces. The plurality of operations additionally comprise: (b) automatically aligning the elongate area in relation to a user defined axis. Moreover, the plurality of operations comprise: (c) performing a stack of the subset of traces defined by the elongate area and outputting a result to a 3D seismic output volume. The plurality of operations also comprise: (d) repeating (b) and (c) for each sample point down the individual seismic trace and outputting each result to the 3D seismic output volume. Additionally, the plurality of operations comprise: (e) positioning the elongate area on another individual seismic trace and repeating (b) through (d).

In another embodiment, a method of enhancing a flat spot in a 3D seismic input volume comprises: (a) enclosing a subset of traces within an elliptical area, wherein the elliptical area is defined along a horizontal plane and centered on an individual seismic trace. The method also comprises: (b) automatically aligning the elliptical area longitudinally in relation to structure strike. Additionally, the method comprises: (c) performing a stack of the subset of traces defined by the elongate area and outputting the results to a 3D seismic output volume. The method further comprises: (d) repeating (c) for each time point down the individual seismic trace and outputting the results to the 3D seismic output volume. In addition, the method comprises: (e) repeating (a) through (d) for a one or more seismic traces within the seismic input volume, and wherein at least one of (a) through (d) is performed on a computer.

The foregoing has outlined rather broadly the features and technical advantages of the invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1A illustrates a 3D schematic representation how an embodiment of the method for enhancing flat spots is used with a seismic input volume;

FIG. 1B illustrates a 3D schematic representation how an embodiment of the method for enhancing flat spots is used with a seismic input volume;

FIG. 1C illustrates a 2D schematic representation of how an embodiment of the method for enhancing flat spots is used with a seismic input volume;

FIG. 1D illustrates a 2D schematic representation of how an embodiment of the method for enhancing flat spots is capable of guiding or orienting an elongate area operator to the local geology;

FIG. 2 illustrates a flowchart of an embodiment of a method for enhancing flat spots;

FIG. 3 illustrates a sample display for optimizing the elongate areas in an embodiment of the method;

FIG. 4 illustrates another embodiment of the method for enhancing flat spots.

FIG. 5 illustrates a schematic of a system which may be use in conjunction with embodiments of the disclosed methods;

FIG. 6 illustrates a comparison of a vertical seismic section before and after flat spot enhancement with an embodiment of the disclosed method; and

FIG. 7 illustrates a horizontal view of a seismic volume after using an embodiment of the flat spot enhancement method.

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

As used herein, a “dip azimuth” refers to the direction of maximum dip of a picked surface or seismic event (i.e., the compass orientation) in the direction of the dip magnitude.

As used herein, “ellipse” or “elliptical” refers to a non-circular and oval shape having a major axis, a, and a minor axis, b, where a is greater than b.

As used herein, “elongate” refers to any non-circular shape which has a length greater than its width.

As used herein, “flat spot” refers to a seismic attribute anomaly that appears as a strong horizontal reflector cutting across the other dipping seismic reflections present on the seismic image. Flat spots are generally regarded as one of the most definitive indicators of hydrocarbons in the subsurface.

As used herein, “horizontal stack” or “horizontal stacking” refers to an operation on a set of traces which sums all the amplitudes at the same time or depth point.

As used herein, “longitudinal” or “longitudinally” refers to orienting an elongate shape or area lengthwise to an axis.

As used herein, “seismic trace” refers to the recorded data from a single seismic recorder or seismograph and typically plotted as a function of time or depth.

### DETAILED DESCRIPTION OF THE PREFERRED EMBODIMENTS

Referring now to the Figures, embodiments of the disclosed methods will be described. As a threshold matter, embodiments of the methods may be implemented in numerous ways, as will be described in more detail below, including for example as a system (including a computer processing system), a method (including a computer implemented method), an apparatus, a computer readable medium, a computer program product, a graphical user interface, a web portal, or a data structure tangibly fixed in a computer readable memory. Several embodiments of the disclosed methods are discussed below. The appended drawings illustrate only typical embodiments of the disclosed methods and therefore are not to be considered limiting of its scope and breadth.

Embodiments of the disclosed methods assume a plurality of seismic traces have been acquired as a result of a seismic survey using any methods known to those of skill in the art. A seismic survey may be conducted over a particular geographic region whether it be in an onshore or offshore context. A survey may be a three dimensional (3D) or a two dimensional (2D) survey. The raw data collected from a seismic survey are unstacked (i.e., unsummed) seismic traces which contain digital information representative of the volume of the earth lying beneath the survey. Methods by which such data are obtained and processed into a form suitable for use by seismic processors and interpreters are well known to those skilled in the art. Additionally, those skilled in the art will recognize that the processing steps that seismic data would normally go through before it is interpreted: the choice and order of the processing steps, and the particular algorithms involved, may vary markedly depending on the particular seismic processor, the signal source (dynamite, vibrator, etc.), the survey location (land, sea, etc.) of the data, and the company that processes the data.

The goal of a seismic survey is to acquire a set of seismic traces over a subsurface target of some potential economic importance. Data that are suitable for analysis by the methods disclosed herein might consist of, for purposes of illustration only, a 2-D stacked seismic line extracted from a 3-D seismic survey or, a 3-D portion of a 3-D seismic survey. However, it is contemplated that any 3-D volume of seismic data might potentially be processed to advantage by the methods disclosed herein. Although the discussion that follows will be described in terms of traces contained within a stacked and migrated 3-D survey, any assembled group of spatially related seismic traces could conceivably be used. After the seismic data are acquired, they are typically brought back to the processing center where some initial or preparatory processing steps are applied to them.

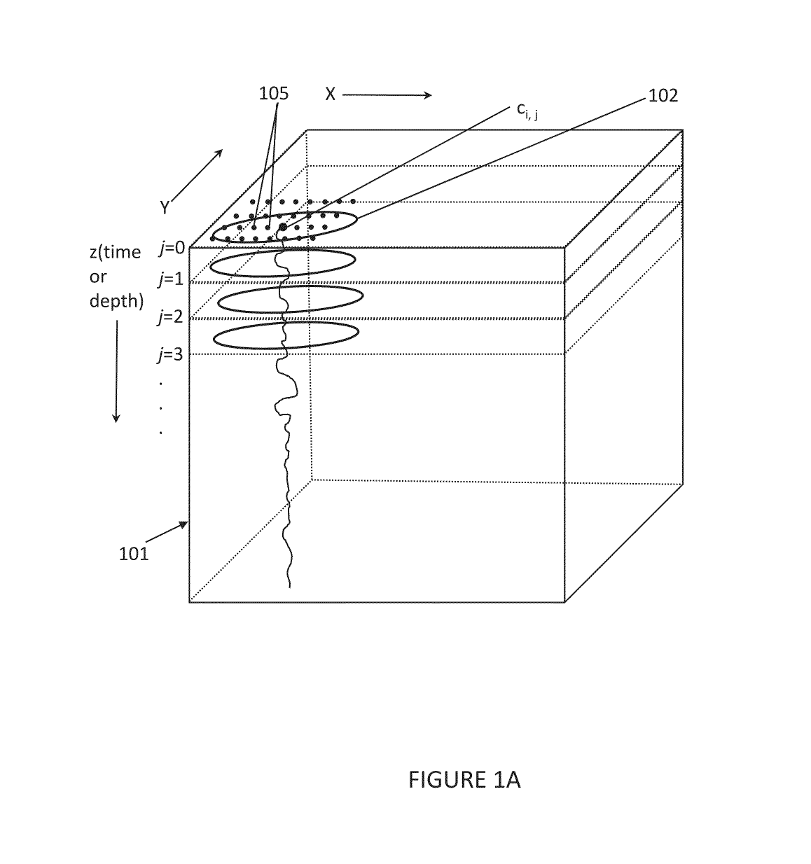

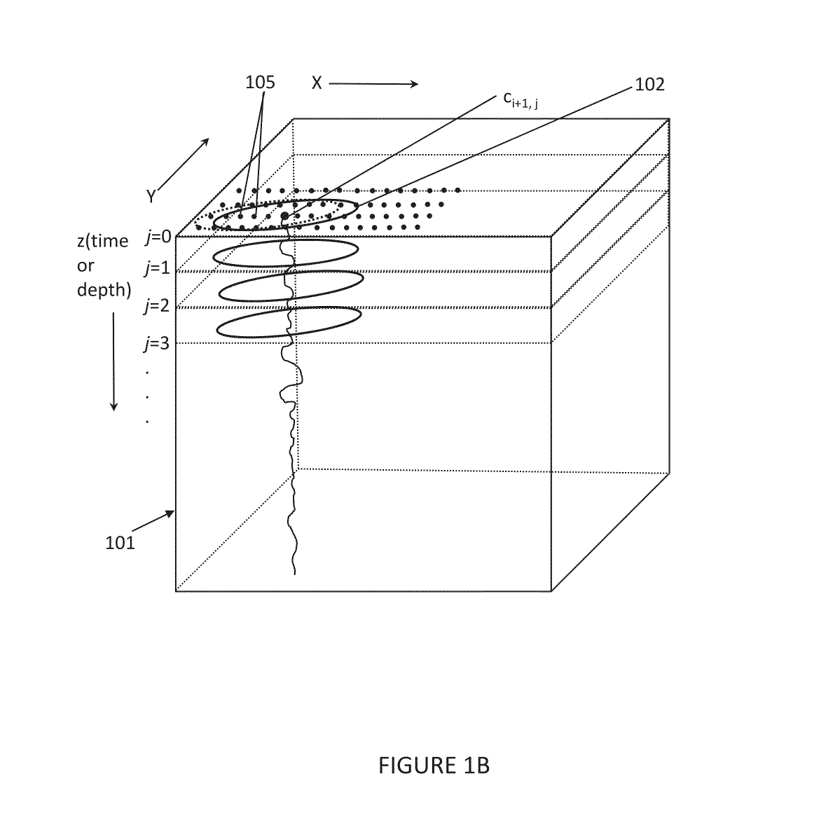

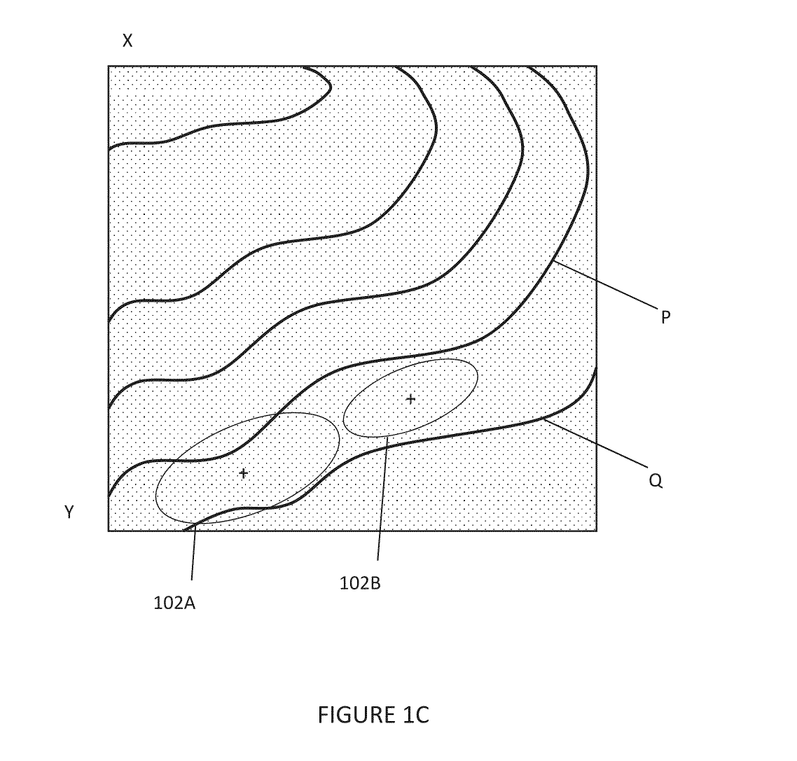

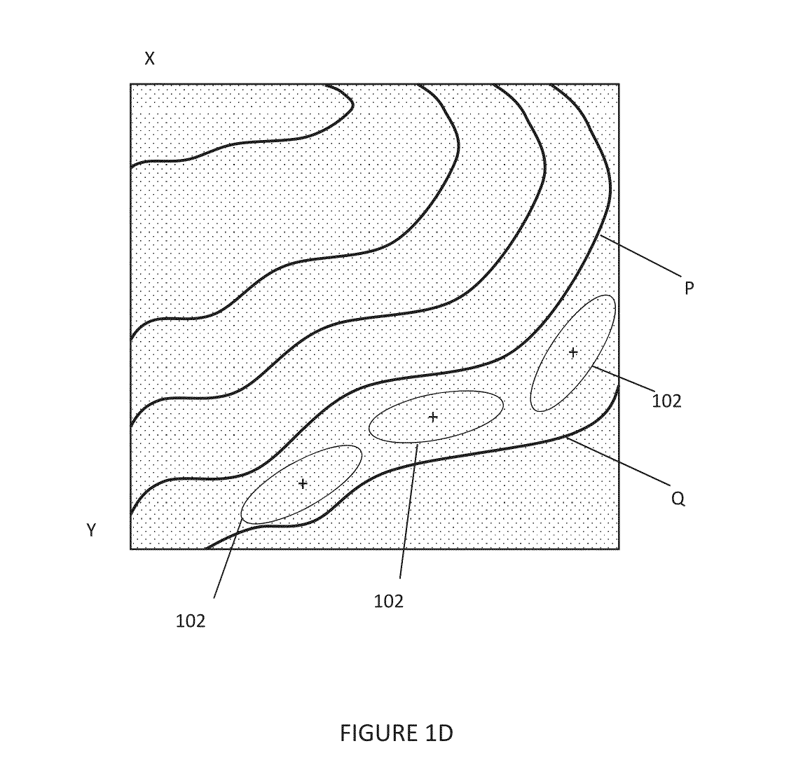

The methods disclosed herein may be applied at the data enhancement stage, the general object of the disclosed methods being to use the seismic input volume 101 to produce a “seismic output cube” which can then be utilized by the interpreter in his or her quest for subterranean exploration formations, specifically flat spot identification. It might also contain other attributes that are correlated with seismic hydrocarbon indicators. FIGS. 1A-C and 2 illustrate visually an embodiment of a method and includes a flow chart that illustrates an embodiment of the disclosed method, wherein a flat spot is enhanced.

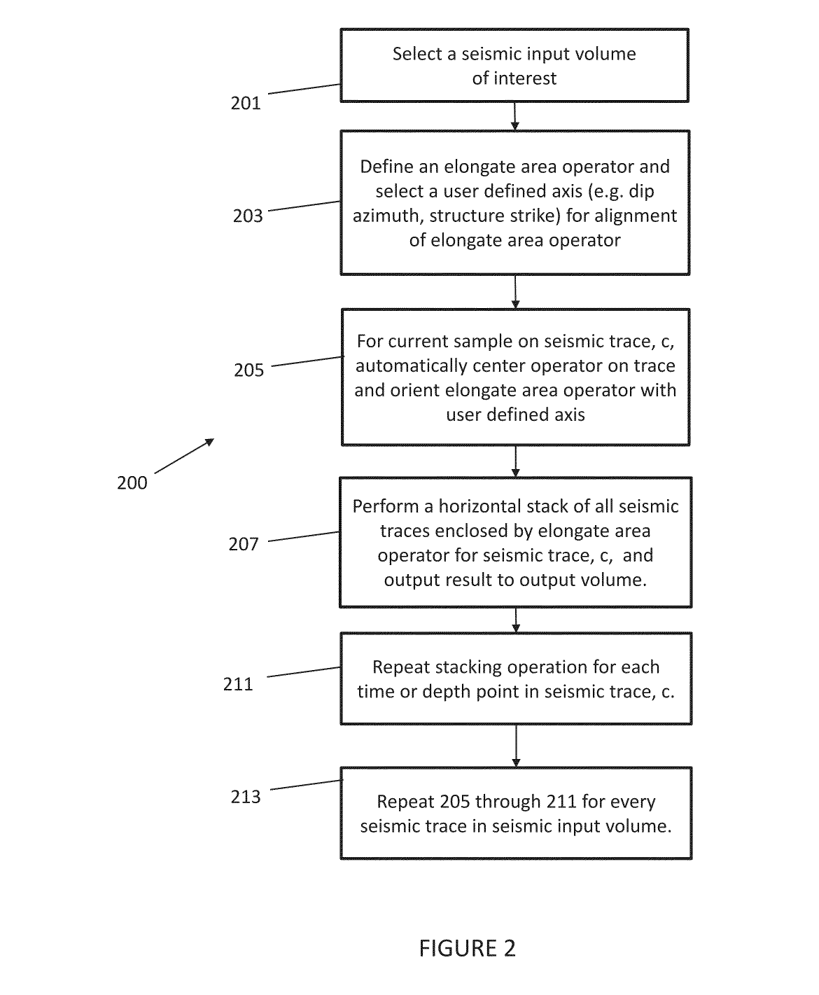

Referring now to FIGS. 1A-C and 2, in an embodiment, the method of enhancing a flat spot generally involves an operation of horizontally stacking (summing) traces within a user defined area 102. As will be discussed in more detail below, the area 102 is centered on a single trace, c_{i,j}, in a 3D seismic input volume 101 where subscript i represents the trace number and subscript j represents the sample number in that particular trace. For example, c_{3,10} refers to sample number 10 in designated seismic trace number 3 in seismic volume 101. As shown and known in the art, seismic input volume 101 has three axes: an x axis and a y axis representing the horizontal plane, and the z axis representing time or depth. More particularly, referring to FIGS. 1A-1B and FIG. 2, a seismic input cube or volume 101 representing a region of interest is selected through geological analysis, or other methods known to those of skill in the art in 201 of FIG. 2. The seismic input volume 101 may also be a subset or sub-volume of a larger seismic input volume of which a user desires flat spot enhancement in accordance with the embodiments disclosed herein. Nevertheless, as described above, the 3D seismic input volume contains many seismic traces 105 (as represented by the individual dots) acquired from a 3D seismic survey. For the sake of clarity, only a sampling of the seismic traces 105 are shown for illustrative purposes in the volumetric representations in FIGS. 1A and 1B.

Referring now to FIG. 2, in 203, the dimensions of an elongate area or operator are selected. In an embodiment, the user defined area 102 may be an elliptical area or ellipse. However, it is contemplated the area or operator may be any suitable elongate shape which is capable of being aligned with the alignment axis such as without limitation, a rectangle, a polygon, or even a curvilinear shape. The user may also select an orientation direction or axis for the elongate area 102 to be aligned in 203. The elongate area 102 may then be aligned with a user defined axis or alignment axis in 205. As used herein, “user defined axis” and “alignment axis” may be used interchangeably to mean an orientation direction or axis selected by a user to which the elongate area operator 102 is aligned. Supported orientation directions or defined axes for the alignment of the elongate area 102 include without limitation, dip azimuth (read from a dip azimuth volume, a dip component volume, apparent dip volumes, a picked structural azimuth surface, or derived from a picked structure surface), fixed inline, fixed crossline, or arbitrary user track (traverse) through the 3D volume. As mentioned above, elongate area 102 is centered on a sample number j, of seismic trace, c_{i,j}, in a 3D seismic input volume 101.

In an embodiment where the elongate area is an elliptical area, the designated “steering axis” may be automatically aligned to the dip azimuth. Either axis, a or b, of the ellipse may be designated as the “steering axis.” However, the steering axis may be aligned with any chosen orientation direction or alignment axis. More particularly, the steering axis may be oriented with any of the user defined axes described herein (e.g. dip azimuth, inline, crossline, etc.).

In an embodiment, elongate area 102 may be defined and oriented to the dip azimuth according to the following equation:

$$\frac{( {x}^{2} + ( {y}^{2} - {x}^{2} ) sin {θ}^{2} - 2 xy sin θcosθ}{{a}^{2}} + \frac{( {y}^{2} + ( {x}^{2} - {y}^{2} ) sin {θ}^{2} - 2 xy sin θcosθ}{{b}^{2}} = 1 \qquad ( 1 )$$

Where x and y are coordinates in a Cartesian coordinate system, a is the length of the major axis, b is the length of the minor axis, and θ is the angle at which the ellipse should be adjusted based on the user defined axis or direction. By way of example only, if dip azimuth is the chosen alignment axis or direction, then the dip azimuth for seismic trace, c_{i,j} would be used as the value of θ. More particularly, seismic traces may be tested for inclusion in the aligned elliptical area by substituting the distance or displacement from the x-y coordinates of the test seismic trace from the seismic trace, c_{i,j}, into equation (2) which has been rotated to a set of axes aligned with the selected orientation direction, θ, of user defined axis.

$$\frac{( Δ {x}^{2} + ( Δ {y}^{2} - Δ {x}^{2} ) sin {θ}^{2} - 2 Δ x Δ y sin θcosθ}{{a}^{2}} + \frac{( Δ {y}^{2} + ( Δ {x}^{2} - Δ {y}^{2} ) sin {θ}^{2} - 2 Δ x Δ y sin θcosθ}{{b}^{2}} \leq 1 \qquad ( 2 )$$

where Δx=(x−x_{c}) and Δy=(y−y_{c}) represent the distance or displacement of the x-y coordinates of the test seismic trace from the seismic trace, c_{i,j}, and x_{c}, y_{c} are the coordinates of center seismic trace, c_{i,j}. When the displacements or distances of the x-y coordinates of the test seismic trace from the seismic trace c_{i,j} are substituted into equation (2) and the resultant value is less than or equal to 1 then the test seismic trace is included in the stacking operation in 207. If the resultant value is greater than 1 then that seismic trace is excluded.

By aligning the elongate area 102 with an alignment axis selected by the user, and with appropriate choice of major and minor axis length, it is possible to constrain the stacking operation within geologic strata, allowing the user to image even narrow flat events that wrap around a subterranean structure. FIG. 1D illustrates schematically the theoretical placement of an exemplary sampling of the areas 102 as they are aligned during the process 200. To avoid confusion, FIGS. 1C and 1D show a view looking down from above the seismic input volume 101 rather than a vertical section of volume 101.

In embodiments where the user defined area 102 is an ellipse, the user may specify the lengths of the major and minor axes, a and b, respectively of the ellipse. By doing so, the user can define or choose how many traces 105 to include in defined elongate area operator 102. That is, user can define the area of the operator 102. In addition, a user may define how long and/or narrow the elongate area 102 may be depending on the subterranean landscape and formations. By way of example only, referring to FIG. 1C, elliptical area 102A is too wide in the subterranean structure, and therefore including the traces reflecting strata P and Q. However, elliptical area 102B is appropriately sized and does not overlap strata P and Q. Thus, one advantage of the disclosed methods is optimizing the elongate area 102 to avoid inclusion of data from inhomogeneous geologic structures and thereby enhancing the presence of any flat spots.

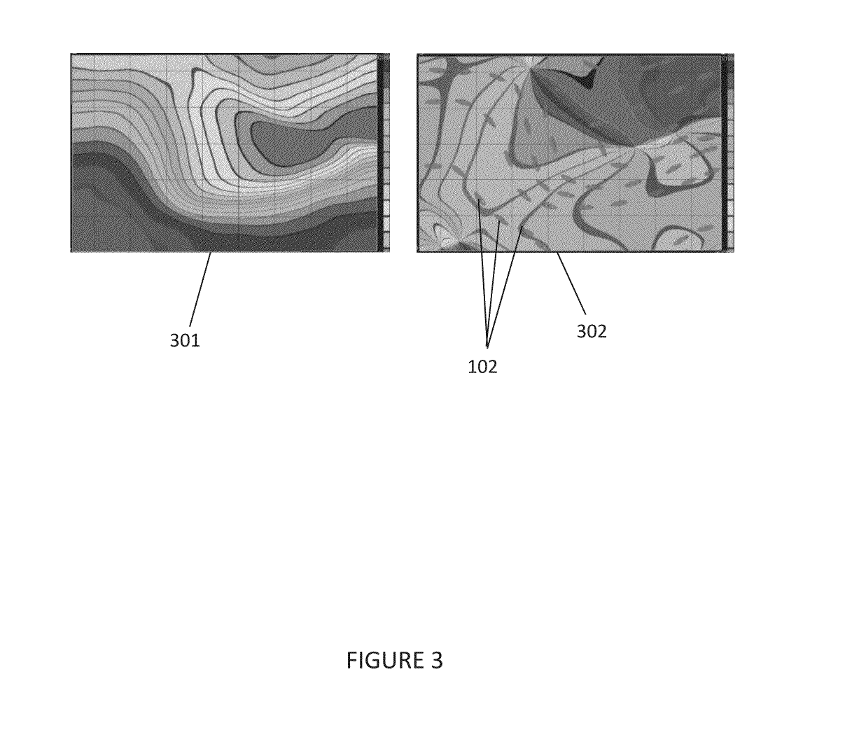

In a further embodiment, referring to FIG. 3, a preview of the size and orientation of a sampling of areas 102 may be displayed prior to the computer intensive stacking operations. Window 301 is a display of the time (depth) structure map and window 302 is a display of the areas 102 in a dip azimuth map. The side by side display enables a user to ensure the areas 102 are the optimal size.

In yet another embodiment, the elongate area 102 may be automatically adjusted for each trace 105. That is, depending on the subterranean formation as determined by the subset of traces contained within area 102, the elongate area 102 may be automatically optimized by size and/or shape.

In 209, the subset of traces defined by the elongate area 102 is then stacked (i.e. summed). The subset of traces defined by the elongate area 102, depending on the user or the subterranean terrain, may include traces that land on the border or edge of elongate area 102. This may be adjusted by modifying equation (2) such that only test seismic traces which are less than 1 are included in the stacking operation. As such, this disclosure contemplates embodiments where traces on the border of elongate area 102 may be included or excluded for the stacking operation. The result of the stacking operation is then written to a corresponding 3D output seismic volume.

In the stacking operation 207 and 211, traces which are contained or defined by the operator 102 may be weighted, from the seismic trace at the center, c_{i,j}, of the area 102 outward, with weights chosen from several bi-variate (x-y) distributions including without limitation, uniform, Gaussian, exponential, and triangular. In operation 211, the stacking operation iteratively proceeds down the center seismic trace, cᵢ, in the z direction (corresponding to time or depth) for each sample, j. The seismic traces may be acquired at any sampling rate known to those of skill in the art. By way of example only, each seismic trace may have a data point every 4 ms for 6 s, making a total of 1,501 data points per trace. As the stacking operation iterates down the seismic trace for each sample j=0, 1, 2, 3 . . . in the z direction (e.g. time or depth) the structure and thus the dip azimuth may change. As such, the corresponding orientation of the elongate area 102 may also change or be adjusted in response to any associated structural change. The calculation at sample number j for seismic trace, cᵢ, the ellipse center is the weighted sum of the amplitudes at the corresponding sample j of all of the traces inside the elongate operator (e.g. a horizontal stack). In operation 211, as shown in FIG. 1B the area 102 may then be iteratively progressed so that it is centered on the next adjacent seismic trace (labeled c_{i+1,j} in FIG. 1B) and the subset of traces within the area 102 for each sample j in seismic trace, c_{i+1,j}, are then horizontally stacked. The dashed elongate area represents the previous location of the elongate area 102. In an embodiment, operations 205 through 211 may then be repeated or iterated until every trace 105 and each sample in each trace in the seismic input cube have gone through the process in 205 through 211. Alternatively, operations 205 through 211 may be repeated or iterated or a user defined subset of traces 105 within seismic volume 101.

The flat spot enhancement attribute produced by the bi-variate weighted horizontal stacking operation described above for 207 and 211 may also be referred to as a “simple stack.” The simple stack is effective in dipping strata; obvious flat spots show up at the extremes of the color table when viewed in the seismic interpretation system. However, the attribute properties are those of the sample mean, and there may be some side effects.

For example, the attribute value at a given point can be affected by a few extreme values (e.g. sample amplitudes of high magnitudes, often outliers). A large sum can be generated, and may be spread over a large areal extent, depending on the weighting scheme and operator size. This may appear to be a flat spot, when it actually is not (a “false positive”). Or, an otherwise significant sum can be nullified by the addition of a single sample with negative amplitude, causing a flat spot to be missed.

In view of the above side effects, in a further embodiment, a horizontal coherence attribute may be calculated from the samples within the elongate area operator 102 and this coherance attribute may be applied as an additional weight to the simple stack value. The coherence attribute, an indication of (horizontal) waveform similarity, will show high coherence when all samples are similar polarity (as would be expected when the reflecting surface is a fluid contact). It significantly attenuates higher magnitude stack values that are caused by outliers. In addition, being self-normalizing, it boosts flat spots calculated in areas of low seismic amplitude, moving them to the tails of the distribution where they are more likely to be visible.

In another embodiment, the local structural dip may be employed to avoid false positives. Local structural dip can be estimated from the seismic amplitude data, or the structural dip for a sample can be taken from either the dip cube or the structure surface; it can be applied as a weight by measuring its deviation from the horizontal X-Y plane. A deviation of zero suggests an anticline or flat structure, so the stack value would be zeroed out. However, a non-zero deviation suggests that the stack value has been calculated in a local environment with dip, and thus the stack value is given a weight of 1 (it is allowed to retain its original calculated value). This has the effect of eliminating distracting flat events that are caused solely by the geology.

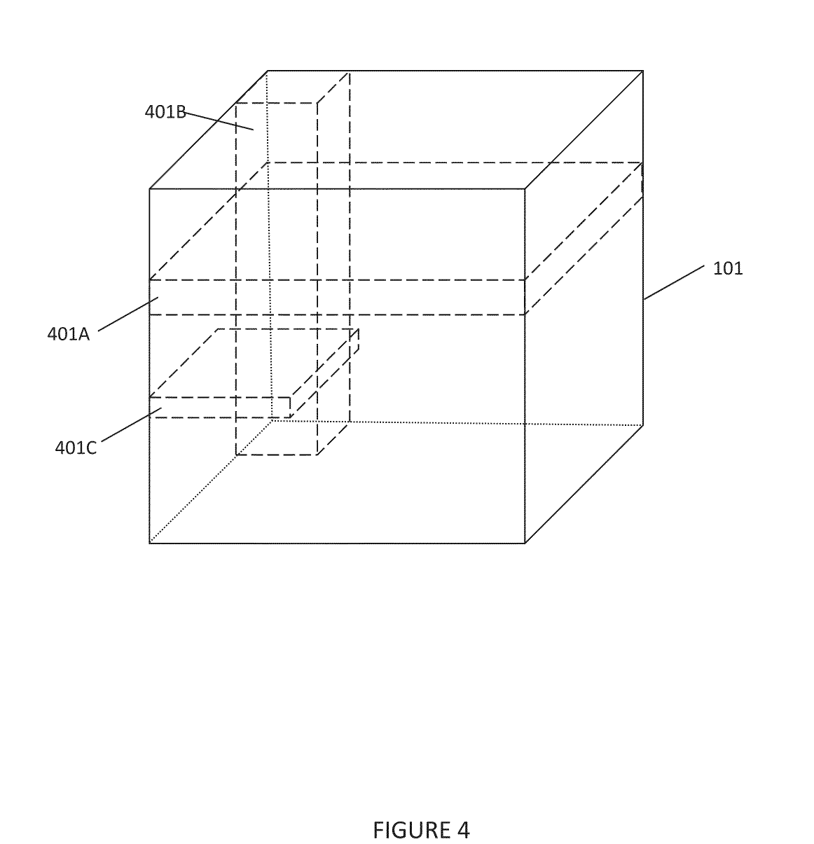

In an embodiment, referring now to FIG. 4, an additional feature (which may be used in combination with the local structural dip weighting) for further enhancement is available when either a target area and/or a target horizon slice, representing a sub-volume 401 of seismic volume 101 is selected for the guided flat spot enhancement. Thus, in an embodiment, the (fully weighted) methods may be constrained to specific sample numbers, j, above and below a selected horizon or surface (i.e. time or depth slice), providing a thin volume 401A for flat spot enhancement. This feature allows the user to focus on specific target areas, usually on the flanks of structures, and deeper in the subsurface, which avoids the flatter near-surface geology. In addition, a smaller target area on the surface may be selected resulting in a narrow seismic volume 401B. For example, only seismic traces c₁ through c₁₀₀ may be selected for flat spot enhancement. Alternatively, both a focused target area and time/depth slice may be selected resulting in a sub-volume 401C be enhanced.

The net result of the selection or target areas and/or horizon slices is the enhancement of flat events in a targeted volume, and which does not contain distracting/irrelevant events. The seismic data outside the target analysis window may be zeroed out, or given a small weight (but is otherwise not processed) so that the output cube contains both enhanced data in the select area of interest and unprocessed data for visual context.

Those skilled in the art will appreciate that the disclosed methods may be practiced using any one or combination of hardware and software configurations, including but not limited to a system having single and/or multi-processor computer processors system, hand-held devices, programmable consumer electronics, mini-computers, mainframe computers, supercomputers, and the like. The disclosed methods may also be practiced in distributed computing environments where tasks are performed by servers or other processing devices that are linked through one or more data communications networks. In a distributed computing environment, program modules may be located in both local and remote computer storage media including memory storage devices.

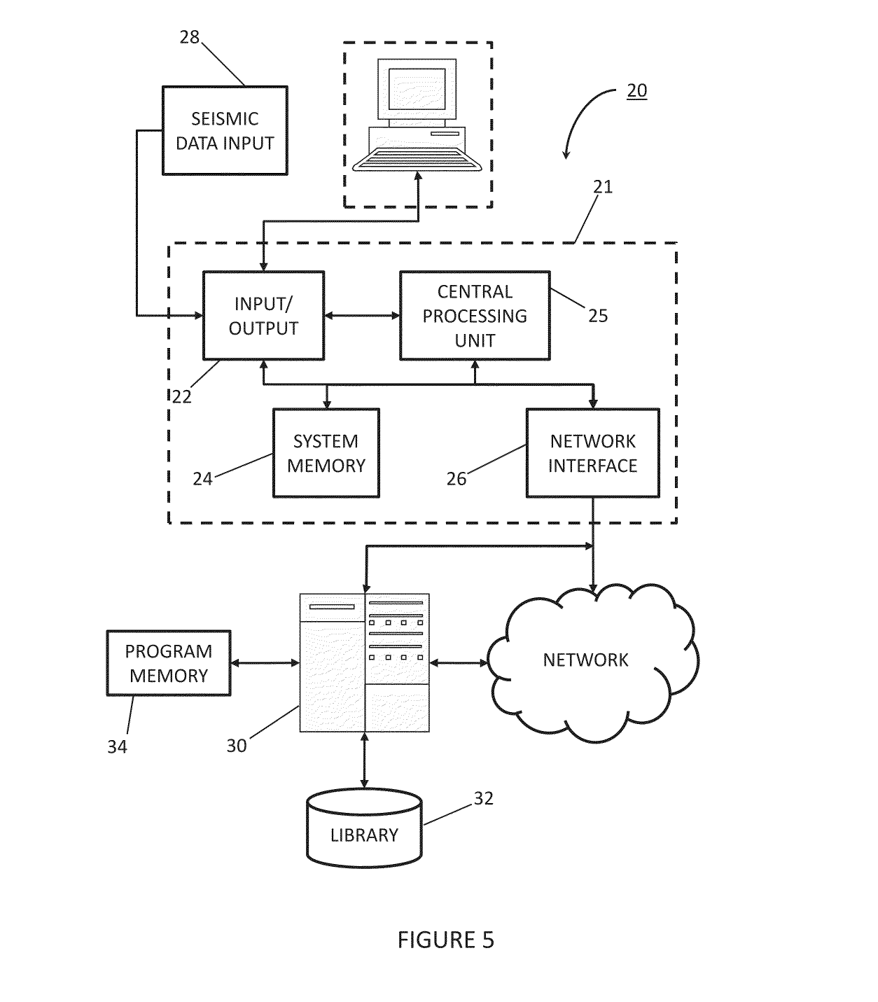

FIG. 5 illustrates, according to an example of an embodiment computer system 20, which may perform the operations described in this specification to perform the operations disclosed in this specification. In this example, system 20 is as realized by way of a computer system including workstation 21 connected to server 30 by way of a network. Of course, the particular architecture and construction of a computer system useful in connection with this invention can vary widely. For example, system 20 may be realized by a single physical computer, such as a conventional workstation or personal computer, or alternatively by a computer system implemented in a distributed manner over multiple physical computers. Accordingly, the generalized architecture illustrated in FIG. 5 is provided merely by way of example.

As shown in FIG. 5 and as mentioned above, system 20 may include workstation 21 and server 30. Workstation 21 includes central processing unit 25, coupled to system bus. Also coupled to system bus BUS is input/output interface 22, which refers to those interface resources by way of which peripheral functions P (e.g., keyboard, mouse, display, etc.) interface with the other constituents of workstation 21. Central processing unit 25 refers to the data processing capability of workstation 21, and as such may be implemented by one or more CPU cores, co-processing circuitry, and the like. The particular construction and capability of central processing unit 25 is selected according to the application needs of workstation 21, such needs including, at a minimum, the carrying out of the functions described in this specification, and also including such other functions as may be executed by computer system. In the architecture of allocation system 20 according to this example, system memory 24 is coupled to system bus BUS, and provides memory resources of the desired type useful as data memory for storing input data and the results of processing executed by central processing unit 25, as well as program memory for storing the computer instructions to be executed by central processing unit 25 in carrying out those functions. Of course, this memory arrangement is only an example, it being understood that system memory 24 may implement such data memory and program memory in separate physical memory resources, or distributed in whole or in part outside of workstation 21. In addition, as shown in FIG. 5, seismic data inputs 28 that are acquired from a seismic survey are input via input/output function 22, and stored in a memory resource accessible to workstation 21, either locally or via network interface 26.

Network interface 26 of workstation 21 is a conventional interface or adapter by way of which workstation 21 accesses network resources on a network. As shown in FIG. 5, the network resources to which workstation 21 has access via network interface 26 includes server 30, which resides on a local area network, or a wide-area network such as an intranet, a virtual private network, or over the Internet, and which is accessible to workstation 21 by way of one of those network arrangements and by corresponding wired or wireless (or both) communication facilities. In this embodiment of the invention, server 30 is a computer system, of a conventional architecture similar, in a general sense, to that of workstation 21, and as such includes one or more central processing units, system buses, and memory resources, network interface functions, and the like. According to this embodiment of the invention, server 30 is coupled to program memory 34, which is a computer-readable medium that stores executable computer program instructions, according to which the operations described in this specification are carried out by allocation system 30. In this embodiment of the invention, these computer program instructions are executed by server 30, for example in the form of a “web-based” application, upon input data communicated from workstation 21, to create output data and results that are communicated to workstation 21 for display or output by peripherals P in a form useful to the human user of workstation 21. In addition, library 32 is also available to server 30 (and perhaps workstation 21 over the local area or wide area network), and stores such archival or reference information as may be useful in allocation system 20. Library 32 may reside on another local area network, or alternatively be accessible via the Internet or some other wide area network. It is contemplated that library 32 may also be accessible to other associated computers in the overall network.

The particular memory resource or location at which the measurements, library 32, and program memory 34 physically reside can be implemented in various locations accessible to allocation system 20. For example, these data and program instructions may be stored in local memory resources within workstation 21, within server 30, or in network-accessible memory resources to these functions. In addition, each of these data and program memory resources can itself be distributed among multiple locations. It is contemplated that those skilled in the art will be readily able to implement the storage and retrieval of the applicable measurements, models, and other information useful in connection with this embodiment of the invention, in a suitable manner for each particular application.

According to this embodiment, by way of example, system memory 24 and program memory 34 store computer instructions executable by central processing unit 25 and server 30, respectively, to carry out the disclosed operations described in this specification, for example, by way of which the elongate area may be aligned and also the stacking of the traces within the elongate area. These computer instructions may be in the form of one or more executable programs, or in the form of source code or higher-level code from which one or more executable programs are derived, assembled, interpreted or compiled. Any one of a number of computer languages or protocols may be used, depending on the manner in which the desired operations are to be carried out. For example, these computer instructions may be written in a conventional high level language, either as a conventional linear computer program or arranged for execution in an object-oriented manner. These instructions may also be embedded within a higher-level application. Such computer-executable instructions may include programs, routines, objects, components, data structures, and computer software technologies that can be used to perform particular tasks and process abstract data types. It will be appreciated that the scope and underlying principles of the disclosed methods are not limited to any particular computer software technology. For example, an executable web-based application can reside at program memory 34, accessible to server 30 and client computer systems such as workstation 21, receive inputs from the client system in the form of a spreadsheet, execute algorithms modules at a web server, and provide output to the client system in some convenient display or printed form. It is contemplated that those skilled in the art having reference to this description will be readily able to realize, without undue experimentation, this embodiment of the invention in a suitable manner for the desired installations. Alternatively, these computer-executable software instructions may be resident elsewhere on the local area network or wide area network, or downloadable from higher-level servers or locations, by way of encoded information on an electromagnetic carrier signal via some network interface or input/output device. The computer-executable software instructions may have originally been stored on a removable or other non-volatile computer-readable storage medium (e.g., a DVD disk, flash memory, or the like), or downloadable as encoded information on an electromagnetic carrier signal, in the form of a software package from which the computer-executable software instructions were installed by allocation system 20 in the conventional manner for software installation.

### Example

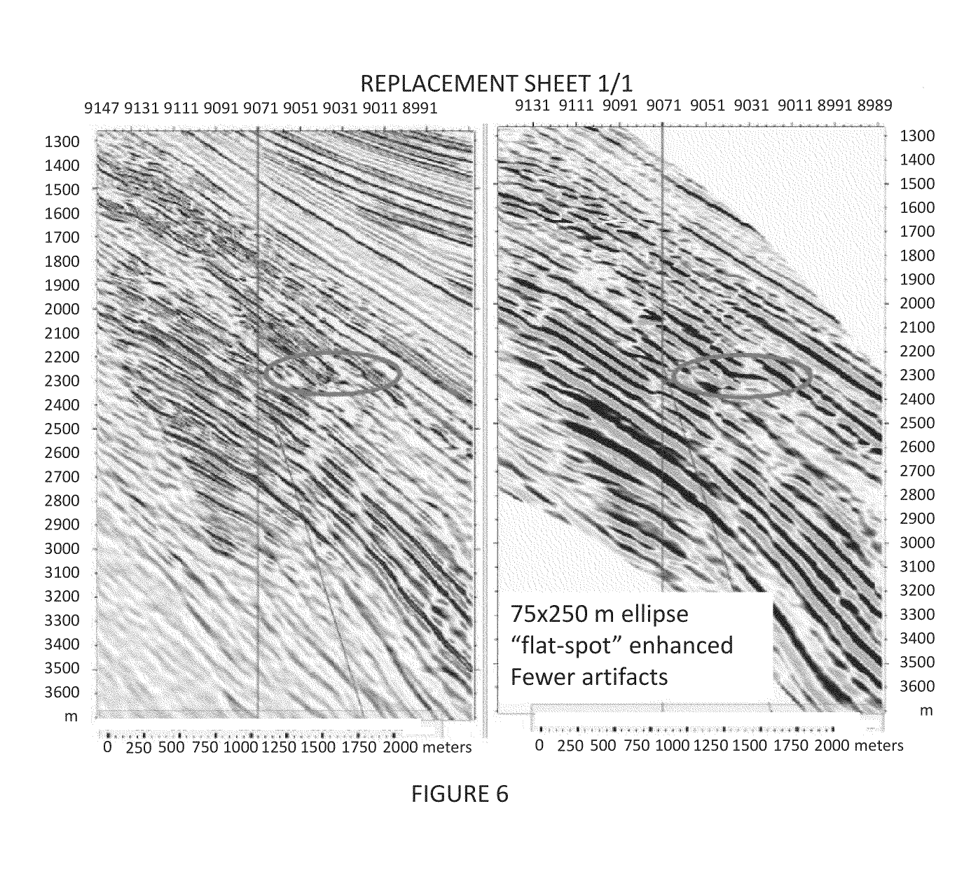

Referring now to FIG. 6, an embodiment of the method for enhancing flat spots was applied to a sample seismic input volume. The seismic vertical section on the left is shown prior to enhancement with the disclosed method. The red oval encircles the flat spot which can barely be seen as surrounded by the other numerous dipping events. The seismic vertical section on the right is shown after enhancement by the disclosed method. The flat spot is clearly shown and is much more easily identified in the encircled area.

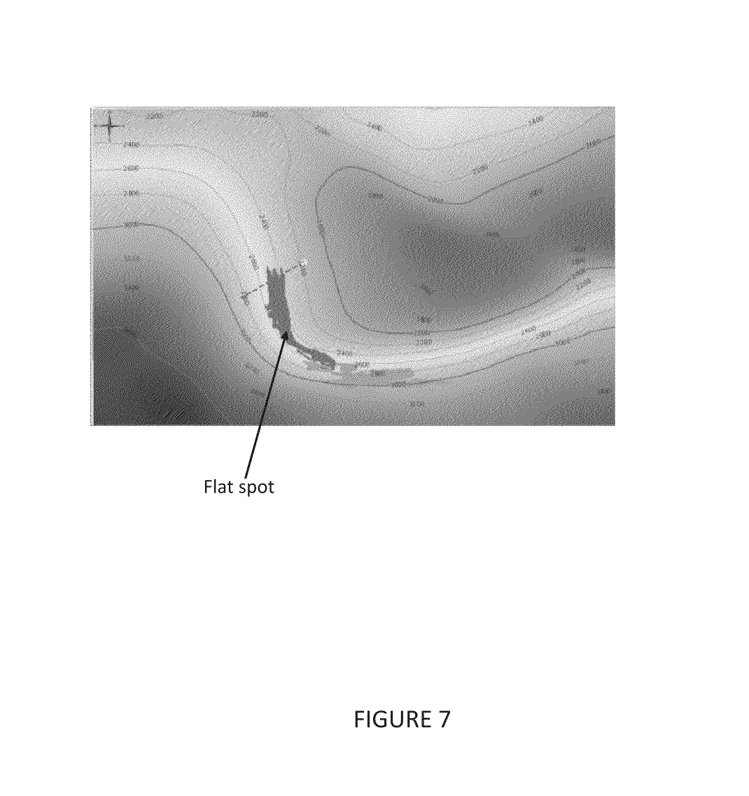

FIG. 7 shows the results of an interpretation after using an embodiment of the flat spot enhancement method. Because every seismic trace within a seismic input volume is subject to the method, a very detailed view of the top of the flat spot may be created as a result of the method.

While the embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

The discussion of a reference is not an admission that it is prior art to the present invention, especially any reference that may have a publication date after the priority date of this application. The disclosures of all patents, patent applications, and publications cited herein are hereby incorporated herein by reference in their entirety, to the extent that they provide exemplary, procedural, or other details supplementary to those set forth herein.

What is claimed is:

1. A method of enhancing a flat spot for seismic interpretation, the method comprising:
(a) selecting a three-dimensional (3D) seismic input volume representing a subterranean region, the 3D seismic input volume comprising a plurality of seismic traces;
(b) defining an elongate area along a horizontal plane, wherein the elongate area is centered on an individual seismic trace within the seismic input volume, and wherein the elongate area encloses a subset of the plurality of seismic traces;
(c) automatically aligning the elongate area in relation to a user defined axis;
(d) performing a stack of the subset of traces defined by the elongate area and outputting a result to a 3D seismic output volume;
(e) repeating (c) and (d) for each sample point down the individual seismic trace and outputting each result to the 3D seismic output volume; and
(f) positioning the elongate area on another individual seismic trace and repeating (c) through (e), and wherein at least one of (a) through (f) is performed on a computer.

2. The method of claim 1 wherein the elongate area is elliptical.

3. The method of claim 1 wherein the elongate area is a polygonal shape, a rectangular shape, or a curvilinear shape.

4. The method of claim 1 wherein the user defined axis comprises dip azimuth, structure strike, inline axis, crossline axis, or an arbitrary line.

5. The method of claim 1 wherein the elongate area remains the same size during (b) through (f).

6. The method of claim 1 wherein the elongate area automatically changes size after (b).

7. The method of claim 1 wherein the elongate area automatically changes shape after (b).

8. The method of claim 1, wherein the subset of traces are weighted in (d) or (e) during the stack.

9. The method of claim 8, wherein the subset of traces are weighted according to a bivariate distribution comprising a uniform distribution, a Gaussian distribution, an exponential distribution, or triangular distribution, or combinations thereof.

10. The method of claim 1 wherein the result from (c) or (d) is weighted by a covariate attribute.

11. The method of claim 10 wherein the covariate attribute comprises coherence.

12. The method of claim 1, further comprising repeating (c) through (f) for each seismic trace within the seismic input volume.

13. The method of claim 12 wherein the seismic input volume is a sub-volume of a larger seismic input volume.

14. The method of claim 1, further comprising displaying a preview of one or more of the elongate areas on a horizontal view of the seismic input volume so as to determine an optimum size of the elongate area, prior to (d).

15. A computer system, comprising:
an interface for receiving a 3D seismic input volume, the 3D seismic input volume
comprising a plurality of seismic traces;
a memory resource;
input and output functions for presenting and receiving communication signals to and from a human user;
one or more central processing units for executing program instructions; and program memory, coupled to the central processing unit, for storing a computer program including program instructions that, when executed by the one or more central processing units, cause the computer system to perform a plurality of operations for enhancing flat spots within the seismic input volume, the plurality of operations comprising:
(a) defining an elongate area along a horizontal plane, wherein the elongate area is centered on an individual seismic trace within the seismic input volume, and wherein the elongate area encloses a subset of the plurality of seismic traces;
(b) automatically aligning the elongate area in relation to a user defined axis;
(c) performing a stack of the subset of traces defined by the elongate area and outputting a result to a 3D seismic output volume;
(d) repeating (b) and (c) for each time point down the individual seismic trace and outputting each result to the 3D seismic output volume; and
(e) positioning the elongate area on another individual seismic trace and repeating (b) through (d).

16. The system of claim 15 wherein the elongate area is elliptical.

17. The system of claim 15 wherein the elongate area is a polygonal shape, a rectangular shape, or a curvilinear shape.

18. The system of claim 15 wherein the alignment axis comprises dip azimuth, structure strike, inline axis, crossline axis, or an arbitrary line.

19. The system of claim 15 wherein the elongate area automatically changes size after (b).

20. The system of claim 15 wherein the elongate area automatically changes shape after (b).

21. The system of claim 15, wherein the subset of traces are weighted in (c) or (d) during the stack.

22. The system of claim 15, wherein the subset of traces are weighted according to a bivariate distribution comprising a uniform distribution, a Gaussian distribution, an exponential distribution, or triangular distribution, or combinations thereof.

23. The system of claim 15, further comprising displaying a preview of one or more of the elongate areas on a horizontal view of the seismic input volume so as to determine an optimum size of the elongate area, prior to (c).

24. The system of claim 15 wherein the result from (c) or (d) is weighted by a covariate attribute.

25. The system of claim 15, further comprising repeating (c) through (e) for each seismic trace within the seismic input volume.

26. The system of claim 25 wherein the seismic input volume is a sub-volume of a larger seismic input volume.

27. A method of enhancing a flat spot in a 3D seismic input volume, the method comprising:
(a) enclosing a subset of traces within an elliptical area, wherein the elliptical area is defined along a horizontal plane and centered on an individual seismic trace;
(b) automatically aligning the elliptical area longitudinally in relation to structure strike;
(c) performing a stack of the subset of traces defined by the elliptical area and outputting the results to a 3D seismic output volume;
(d) repeating (c) for each time point down the individual seismic trace and outputting the results to the 3D seismic output volume; and
(e) repeating (a) through (d) for a one or more seismic traces within the seismic input volume, and wherein at least one of (a) through (d) is performed on a computer.

28. The method of claim 27 wherein (e) comprises repeating (a) through (d) for every seismic trace within the 3D seismic input volume.

29. The method of claim 28 wherein the 3D seismic input volume is a sub-volume of a larger seismic input volume.
